(19) United States
(12) Patent Application Publication
(10) Pub. No.: US 2003/0068458 A1
(43) Pub. Date: Apr. 10, 2003

(54) Trim panel with applied water barrier

(75) Inventors: Mark Pattok, Allegan, MI (US); Daniel F. White, Holland, MI (US); Sandor J. Suli, Sparta, MI (US)

Correspondence Address: FOLEY & LARDNER, 777 EAST WISCONSIN AVENUE, MILWAUKEE, WI, 53202, US

(73) Assignee: Johnson Controls Technology Company

(21) Appl. No.: 09/972,692

(22) Filed: Oct. 5, 2001

(51) Int. Cl. B32B 3/10; B32B 7/06

(52) U.S. Cl. 428/40.1; 428/137

(57) ABSTRACT

A trim panel-water barrier subassembly for vehicle structures includes a film of water impermeable material attached to the panel and a seal (of foam or other resilient sealing material) about at least a portion of the perimeter of the outer surface of the water barrier. The seal may include a treatment on its outermost surface, and preferably a release liner is employed to facilitate shipping and assembly of the trim panel. The treatment prevents the capillary attraction of water between the seal and the adjacent vehicle structure, thus preventing water leaks and the potential for seal damage due to freeze/thaw cycles. The water barrier is adhesively attached to the trim panel to provide the subassembly. For example, openings in the water barrier are surrounded by adhesive to prevent the leakage of water into the space between the water barrier and the trim panel.

Cross-reference to related applications, if any: None.

### BACKGROUND OF THE INVENTION

1. Field of the Invention

The present invention relates generally to trim panels, especially for vehicles. In its preferred embodiment, a water barrier is attached to the trim panel and includes a seal on the outer surface of the barrier which contacts the sheet metal inner panel of a vehicle structure, e.g., a door. In its most preferred embodiment, the inner surface of the water barrier is attached to the trim panel, preferably with adhesive to surrounding any openings, such as those used for window actuators, door latches and the like, although the adhesive may be applied to other areas as well.

2. Description of the Prior Art

It is been known for many years that it is desirable to prevent water from accumulating in vehicle doors or other structures and especially to prevent water from reaching the interior trim panels, i.e., the panel which is innermost with respect to the vehicle interior. The trim panels include decorative trim materials, as well as operating components for operating systems, such as windows, mirrors, locks and the like. Several illustrative structures of the prior art will be described to illustrate background technology.

Isaksen et al., in their U.S. Pat. No. 4,469,732, issued Sep. 4, 1984, for “Water Deflector for Vehicle Doors” describe a water deflector comprising a rigid sheet of generally planar polyethylene which is peripherally shaped for covering an inner door panel. An adhesive is applied around the two sides and the bottom of the deflector, and patches of adhesive are provided along the upper edge to assist in joining the deflector to the inner panel of the door. Holes may be provided in the deflector for access to door hardware and registration holes may be provided to assist in the transport and assembly of the deflector. There is no reference in this patent to any attachment between the deflector and a door trim module.

In U.S. Pat. No. 4,696,848, issued Sep. 29, 1987, to Jones et al., for “Surface Protector with Expansible Pocket”. A similar deflector is shown, but this deflector also includes corrugated areas which permit bulges or pockets to be formed in the deflector to receive hardware, such as speakers. The adhesive attachment of the deflector to the door trim inner panel is very similar to that shown by the above-referenced Isaksen et al. patent.

Another Isaksen United States patent, U.S. Pat. No. 5,560,967, issued on Oct. 1, 1996, for “Sound-Absorbing Automotive Water Deflector”, and in this case opposed faces of a foam sheet are covered by sheets of foil or film, preferably polyethylene film. At least one laterally deflectable pocket is formed by a plurality of individual, side-by-side closely spaced strips of the foam, with the film bridging the spaces between the spaced strips. This material is also affixed to the inner door panel.

In U.S. Pat. No. 5,902,004 issued May 11, 1999, Waltz et al. describe a “Motor Vehicle Door” which includes a water-deflecting panel which is adhered to the inner door panel using a bead of sealant. This patent specifically concerns the isolation of the door latch using a mounting plate facing an inside door panel and including a sealing element which seals at least a portion of the latch area against moisture.

Finally, Thompson et al. in U.S. Re. Patent No. 36,323, reissued Oct. 5, 1999, describe an “Acoustical Insulating Web” which has a combination of non-woven, sound-absorbing fibers and a film layer adhered thereto which can be scrim, non-woven fabric, film or foil laminated thereto. The patent focuses on the specific fibers used to attain desirable sound attenuation, and the additional layer is provided as a water barrier. The drawings of this patent are nearly identical to those of the aforementioned Jones et al. reference and include the holes for door mechanisms, the corrugated sections for speakers and the like, and adhesive surrounding the sides and bottom to attach the material to the inner door panel. Patches of adhesive are also used in this patent to assist in securing the panel to the top of the inner door panel.

While at least one of the aforementioned references is in commercial production on some vehicle platforms, several deficiencies have yet to be overcome. A desirable water barrier should provide a barrier to prevent water from reaching the trim panel; it should be easy to seal to the vehicle structure; and it should prevent water from leaking through openings provided for operating systems, such as window actuators, handles, latches, and the like. It would also be desirable to provide water barrier-trim panel subassemblies which can be fabricated at a plant remote from that used for final vehicle assembly and which would permit the ready attachment of the trim panel to an inner surface of the vehicle structure at the plant where the vehicle is assembled.

A water barrier system which provides such advantages would represent a substantial advance in this art.

### FEATURES AND SUMMARY OF THE INVENTION

A primary feature of the present invention is to provide a water barrier for a vehicle system which is coupled to the trim panel and easily assembled to an inner surface of a vehicle structure, i.e., the inner surface of a vehicle door.

Another feature of the present invention is to provide a trim panel which includes openings and localized adhesive bonding around the openings to prevent water from entering the space between the water barrier and the trim panel.

Another feature of the present invention is to provide a water barrier attached to a trim panel which includes a peripheral seal, a treatment on the seal, and a release liner thereon to facilitate shipment and assembly of the trim panel at the vehicle assembly plant.

Yet another feature of the present invention is to provide a trim panel with an applied water barrier which is readily adaptable to a wide variety of vehicle structures and a variety of trim panel mounted systems, such as windows, locks, speakers, etc.

A different feature of the present invention is to provide a peripheral seal for a water barrier which is attached to a trim panel.

How the foregoing and other features of the invention are accomplished individually, collectively, and in various subcombinations will be described in the following detailed description of the preferred embodiment of the invention, taken in conjunction with the FIGURES. Generally, however, the features are accomplished in the preferred embodiment by providing a water barrier, which may be a polymeric sheet or other suitable water impervious material, and which may be flexible or more rigid, and which is attached by adhesive to a trim panel, e.g., a door trim panel. A seal, which may be a bead or extruded strip, preferably made of foam, surrounds at least a portion of the periphery of the water barrier on the surface thereof opposite the trim panel. The bead forms a compression seal between the trim panel and an inner surface of a vehicle structure. In a preferred and illustrated embodiment, the seal includes both a chemical treatment layer on its outer surface and a release liner overlying the treatment layer so that shipment and assembly of the trim panel is facilitated. The release liner, such as a peel strip or sheet of waxed paper or the like is preferably removed after attachment of the trim panel to the vehicle structure. Areas surrounding openings in the trim panel are coated with an adhesive which attaches the water barrier to the trim panel and prevents the incursion of water into the area between the barrier and the trim panel.

Other ways in which the features of the present invention are accomplished will become apparent to those skilled in the art after they have read the following detailed description of the preferred embodiment and the remainder of the specification. Such other ways are deemed to fall within the scope of the present invention if they fall within the scope of the claims which follow.

### BRIEF DESCRIPTION OF THE FIGURES

In the various FIGURES, like reference numerals are used to indicate like components and:

FIG. 1 is a perspective view of an illustrative combination of a door trim panel and a water barrier, with a seal on the side of the water barrier opposite the door trim panel;

FIG. 2 is an exploded view of the trim panel shown in FIG. 1 and illustrating in schematic form a vehicle door and a window actuator;

FIG. 3 is a sectional view of a portion of the water barrier compressed against the door inner panel;

FIG. 4 is an illustrative, perspective view of a door trim panel, water barrier and seal, the seal including a chemical treatment layer and being covered by a release liner which may be readily removed after assembly; and

FIG. 5 is a sectional, enlarged view of an alternate embodiment of the invention in which an acoustical layer is attached to the surface of the water barrier which is remote from the door trim panel.

### DETAILED DESCRIPTION OF THE PREFERRED AND ALTERNATE EMBODIMENTS

Before proceeding with the detailed description of the preferred and alternate embodiments of the present invention, several general comments can be made about the applicability and the scope thereof.

First, the present invention is illustrated in connection with a door trim panel to be coupled to the inner surface of a vehicle door, e.g., a steel door. However, the invention has equal applicability to other trim panels used to cover other vehicle structures, such as lift gates, tailgates, cargo floor structures, interior side panels, etc.

Second, the water barrier may be made from a variety of materials including polymer film, fiberglass, foam sheeting, or other suitable water impervious materials, and it may comprise a single layer or a plurality of layers adhered or laminated to one another. Polyolefin films are especially preferred.

Third, the water barrier may have a variety of thicknesses depending on the end use application and on other design criteria. For example, the barrier may have a thickness of from about 1 mm to about 10 mm or more. The barrier may be a flexible film (i.e., it can be bent by hand from its original state by 90° or more without cracking) or it can be more rigid. The selection again will depend upon a number of design criteria and the way in which the water barrier will ultimately be affixed to the inner surface of the vehicle structure. If the barrier requires, it may be thermoformed or laid up into a desired configuration using forming techniques well known in the polymer and fiberglass arts, and it may include structural and/or design features and/or operating components, such as those shown in the patents described above, including pockets for speakers or other door systems. The way in which such pockets are formed and the location thereof can vary widely and will be readily appreciated by those skilled in this art.

Fourth, the present invention illustrates a system in which the water barrier is attached to a door trim panel at multiple locations representing openings for window actuator components and at an elongate adhesive connection area located between the upper two of such actuator openings. The number and location of adhesive attachment points for the water barrier of the present invention may also vary widely depending on the design of trim panel. For example, there may be more or less than four adhesive connections, and not all of them need to surround openings which extend through the barrier material. However, when an opening is provided, it is preferable that the opening be surrounded by adhesive and that the barrier be attached to the trim panel in a surrounding fashion to assist in preventing entry of water into the area between the inner surface of the barrier and the exterior surface of the trim panel.

The type of adhesive employed may also vary widely and be selected from thermoset, thermoplastic, one component, multi-component adhesives, and the like. The adhesives may be applied to one component, or in the case of a thermoplastic adhesive, may be applied to two components to allow the components to be joined by heating the adhesive above its plastic state.

As with the adhesive used to attach the barrier to the trim panel, the seal which is shown in the preferred embodiment can be made from a variety of materials, including soft, semi-open cellular foam, polyurethane foam, a die cut foam, an extruded foam, natural or synthetic rubbers or other similar sealing materials which have the capability of being attached (e.g., by adhesive) to the exterior surface of the barrier and subsequently seal against the inner surface of the vehicle structure. Moreover, the seal need not surround the entire perimeter of the barrier as illustrated. In some cases, it may be desirable to leave openings, for example small holes or slots, in the upper portion of the seal to allow any water which may enter the area between the barrier and the vehicle structure to escape as vapor when the door is warmed above the evaporation point of water. Preferably, the seal is located around at least the sides and the bottom of the barrier.

It is also desirable in some situations, and in the preferred embodiment it is illustrated, to provide a chemical treatment on the outer surface of the seal. It is especially important in this location to prevent capillary action from pulling water into the sealed area, where freeze and thaw cycles can break the seal. Preferred chemical treatments include Teflon®, wax, silicone, scrim, adhesives or other suitable treatments. Adhesives may be desirable for some applications, but they may make access to the space between the trim panel and the vehicle structure difficult or impossible. The presently preferred treatment is wax.

Another feature of the invention is illustrated in connection with the preferred embodiment, that is a release liner which may be separated after assembly from the outer surface of the seal to expose the chemical treatment. A waxy paper or film is preferred. The liner provides advantages during shipping and assembly of the trim panel, in that the treatment area is kept clean until the time of final assembly, and the trim panels may be stacked without causing the seal coating to become contaminated. The removable release liner will allow complex loading kinematics of the trim panel without the treatment on the seal sticking to undesired areas and restricting loading.

Finally, sound-absorbing materials may be attached to the water barrier, on either side thereof, such as the acoustical materials described in the aforementioned Reissue patent to Thompson et al. The materials described in that patent can help in sound attenuation and may be especially preferred when used with a water barrier system in which the barrier material is attached to the trim panel, rather than to the door as indicated in the aforementioned patent.

Proceeding now to a description of the preferred embodiment of the present invention, a water barrier and door trim system 10 according to the present invention includes an inner door panel 12 and a water barrier sheet 14. In the illustrated embodiment, the trim panel 12 includes a variety of structural and mechanical components, including a speaker 16, a door latch system indicated generally at 18, and four attachment mounts 20 for a window actuator described in connection with a later FIGURE. Surrounding each of the lower attachment mounts 20 and surrounding and extending between the upper attachment mounts 20 are areas of adhesive 22 which bond the barrier 14 to the trim panel 12. As indicated previously, the number of such attachment locations may vary depending on the door structure, and adhesive may be applied in areas other than those involving structural components of the trim module.

A seal 25 is shown surrounding the outer surface of barrier 14 and extending about its entire perimeter. The seal 25 may be interrupted as indicated in the introduction above or may only be applied to the sides or to the bottom of the barrier in some applications. In its most preferred form, the seal 25 extends about the entire periphery of barrier sheet 14. Seal 25 is preferably adhered to barrier 14 by an adhesive not shown.

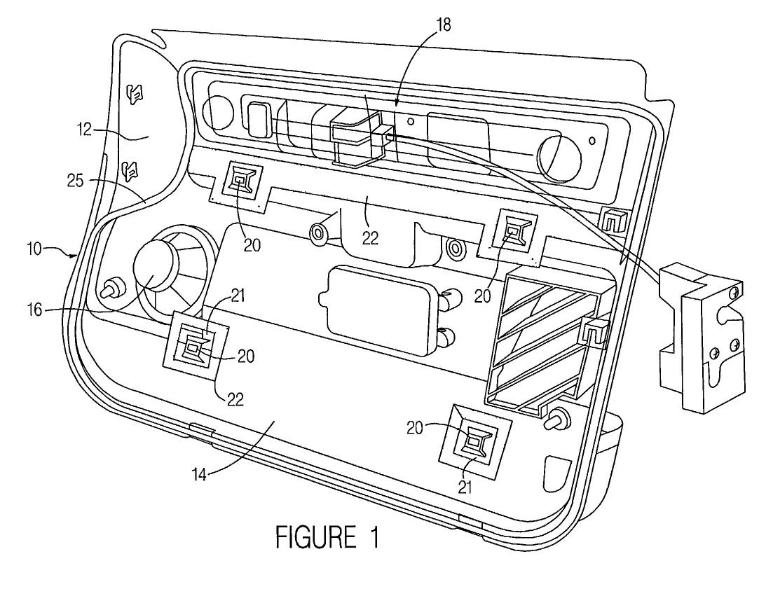

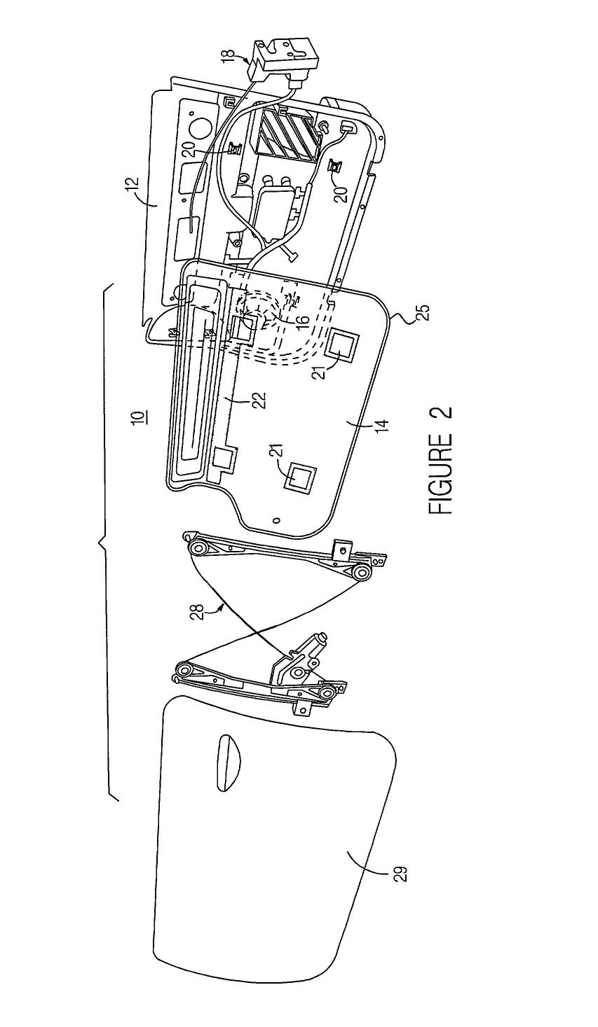

FIG. 2 is an exploded view of the major components of system 10 shown and described in FIG. 1, but also including an illustrative window actuator 28 and a door 29. The components are shown before the adhesive 22 is attached to the trim panel 12, and openings 21 fit over the attachment mounts 20. This FIGURE also shows the barrier sheet 14 and seal 25.

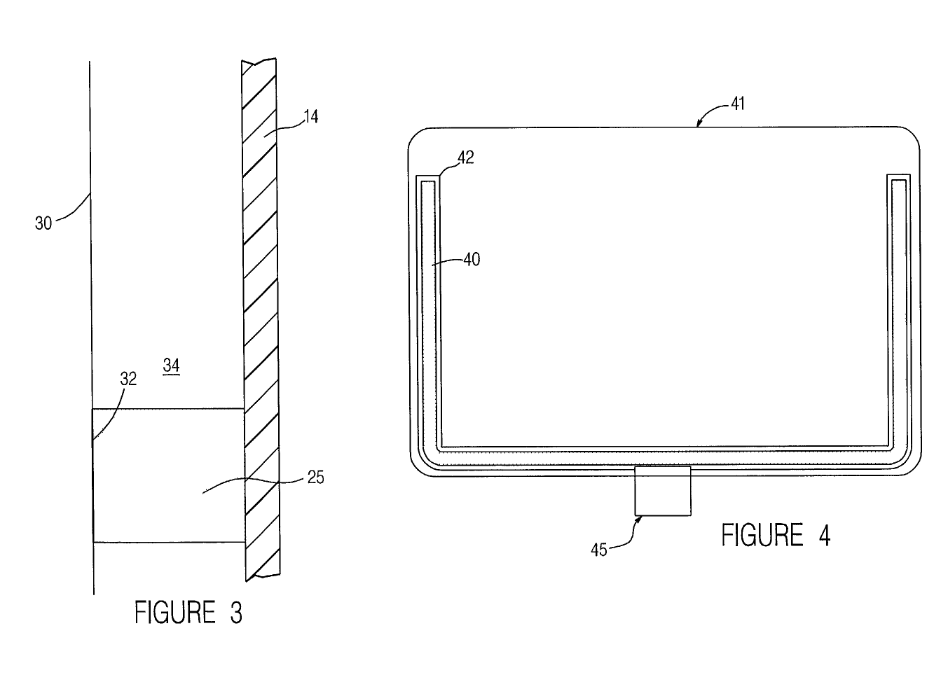

FIG. 3 shows a cross section of the barrier 14 after it has compressed against the inner surface 30 of the door inner panel of door 29. Surface 30 is usually steel, or some other metal (or plastic), and it may be treated for by any of the techniques disclosed in the prior art, including treatment by corona discharge. The seal 25 is also shown in cross section, and between seal 25 and surface is the layer of chemical treatment. If an adhesive is used as the treatment it can be the same or different than adhesive 22 used to adhere barrier 14 to the trim panel 12. Preferably the chemical treatment is wax which will prevent capillary attraction of water around seal 25 and into the area designated 34 between barrier 14 and surface 30. See the beginning section of this portion of the specification for additional preferred properties for the chemical treatment layer.

FIG. 4 shows another embodiment of the present invention. This time using a schematic illustration of a barrier 41 (which may be the same or different from the barrier materials described before but having the same properties). In this FIGURE, a seal 40 is shown schematically surrounding the sides and the bottom of barrier 41. Located on the outer surface of bead 40 is a release strip 42. The strip includes a pull tab 45 to allow it to be easily removed after assembly, exposing the chemical treatment on bead 40. As previously indicated, the shape of the seal 40 and the amount of the perimeter of the barrier 41 to be covered by the seal 40 may be variously embodied, and this barrier 41 may also be thermoformed or otherwise prepared to receive various structures within the door assembly including speakers, locks, window actuators, lights, etc.

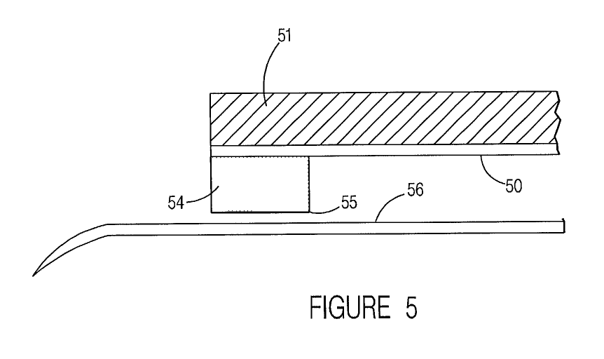

FIG. 5 shows another alternate embodiment of the present invention in schematic form, the door trim module panel not being shown. In this embodiment, the barrier 50 (made from and prepared as described above for other barriers) includes a seal 54 and a chemical treatment layer 55. The inner surface 56 of the door inner panel is shown near but not yet in contact with the barrier structure. On the side of barrier 50, opposite that from which the seal 54 extends, a layer of sound-absorbing fibers 51, such as PET fibers, is provided. The fiber may be selected from those which provide good sound attenuation, including those described in the patents discussed in the background section of this specification. The fiber layer may be provided on either side of barrier 50. For example, fiber could be provided adjacent to the same surface as the seal and be located at areas thereof which do not include the seal.

While the present invention has been described in connection with a preferred and several alternate embodiments, the invention is not to be limited thereto, but it is to be limited by the scope of the claims which follow. Sizes, dimensions, particular materials, particular trim panels and vehicle structures can be widely varied as is known in the art, and hence, the illustrations are for purposes of explaining the invention to the reader rather than to, in any way, limiting the scope hereof.

What is claimed is:

1. A water barrier system for a trim panel for a vehicle comprising:
a trim panel having a first side to be located facing the interior of a vehicle and a second side located facing outwardly of the interior of a vehicle and adapted to be assembled to an inner surface of a vehicle structure; and
a water barrier comprising a sheet of water barrier material joined to the second side of the trim panel.

2. The water barrier system of claim 1, wherein the water barrier sheet comprises a polymeric sheet.

3. The water barrier system of claim 2, wherein the water barrier sheet comprises a polyolefin film sheet.

4. The water barrier system of claim 1, wherein the water barrier sheet includes at least one opening to permit a component to pass through the water barrier sheet, and an adhesive surrounds each opening joining the water barrier sheet to the trim panel.

5. The water barrier system of claim 4, wherein the water barrier sheet includes a plurality of openings to permit a plurality of components to pass through the water barrier sheet and adhesive surrounds each of the openings.

6. The water barrier system of claim 5, wherein adhesive joins the water barrier sheet to the trim panel at locations other than those surrounding openings.

7. The water barrier system of claim 1 further comprising a seal on the second side of the water barrier and adapted to seal the trim panel to an inner panel of the vehicle structure.

8. The water barrier system of claim 7, wherein the seal is a foam bead.

9. The water barrier system of claim 7, wherein the seal extends about at least a portion of the periphery of the water barrier sheet.

10. The water barrier system of claim 9, wherein the seal extends about substantially all of the periphery of the water barrier.

11. The water barrier system of claim 7, wherein the seal includes a surface adapted to contact the inner panel of the vehicle structure during assembly and further comprises a treatment layer thereon.

12. The water barrier system of claim 12, wherein the treatment layer is a layer of a material selected from the group consisting of Teflon®, silicone, wax, scrim or adhesive.

13. The water barrier system of claim 12, wherein a release liner covers the treatment layer and is adapted to be removed after assembly of the trim panel to the inner panel of the vehicle structure.

14. The water barrier system of claim 1, wherein the sheet of water barrier material is joined to the second side of the trim panel by an adhesive.

15. A water barrier system for a vehicle assembly preventing water from contacting a trim panel covering an inner surface of a vehicle structure comprising:
a trim panel including operating or convenience parts and having an inner side adapted to face the interior of a vehicle;
a vehicle structure having an outer side and an inner surface; and
a water barrier sheet having a first side attached to the inner side of the trim panel and a second side contacting the inner surface of the vehicle structure.

16. The water barrier system of claim 15, wherein the second side of the water barrier sheet includes a seal contacting the inner side of the vehicle structure, and a treatment layer located between the seal and the inner surface of the vehicle structure.

17. The water barrier system of claim 16, wherein the seal surrounds substantially all of the periphery of the water barrier sheet.

18. The water barrier system of claim 16, wherein the treatment layer is a layer of a material selected from the group consisting of Teflon®, silicone, wax, scrim or adhesive.

19. The water barrier system of claim 15, wherein the first side of the water barrier sheet is attached to the inner side of the trim panel by adhesive.

20. A method of assembling a trim panel protected by a water barrier sheet to a vehicle structure having an inner surface comprising the steps of:
providing a trim panel and a water barrier sheet;
bonding a first side of the water barrier sheet to the side of the trim panel adapted to face outwardly of the vehicle interior; and
contacting the second side of the water barrier sheet with the inner surface of the vehicle structure.

21. The method of claim 20, wherein the water barrier sheet includes at least one opening to permit a component of the vehicle to pass through the water barrier sheet, and the step of bonding includes applying adhesive about each opening.

22. The method of claim 21, wherein the water barrier sheet includes a plurality of openings and the adhesive is applied about each opening.

23. The method of claim 22, wherein adhesive is applied between the water barrier sheet and the trim panel at locations in addition to those around openings.

24. The method of claim 20, wherein the second side of the water barrier sheet includes a seal having a first portion joined to the second side of the water barrier sheet and a second portion, applying a treatment to the second portion and urging the second portion against the inner surface of the vehicle structure.

25. The method of claim 24, wherein the treatment is a layer of a material selected from the group consisting of Teflon®, silicone, wax, scrim or adhesive.

26. The method of claim 24, wherein the treatment on the second portion is covered by a release liner, and the method comprises the additional step of removing the release liner after the urging step.

27. The method of claim 23, wherein the release liner includes a pull tab and the removal step comprises pulling the release liner away from the water barrier sheet by pulling on the pull tab.
